(19) United States
(12) Patent Application Publication
(10) Pub. No.: US 2018/0170236 A1
(43) Pub. Date: Jun. 21, 2018

(54) MOUNTING ASSEMBLY

(71) Applicant: AIRBORNE SYSTEMS LIMITED, Mid Glamorgan (GB)

(72) Inventor: Martyn Phillip JONES, Mid Glamorgan (GB)

(21) Appl. No.: 15/836,893

(22) Filed: Dec. 10, 2017

(30) Foreign Application Priority Data
Dec. 16, 2016 (GB) 1621499.1

(51) Int. Cl. B60P 7/08

(52) U.S. Cl. CPC B60P 7/0807

(57) ABSTRACT

A mounting assembly for attachment to cargo and for releasable attachment to a fixing point may include a base portion for attachment to the cargo. The mounting assembly also includes a mounting shaft retained by a releasable calliper attached to the fixing point. The mounting shaft has a first end attached to the base portion and a second opposite end. The mounting shaft also has a mounting shaft axis extending between the two ends. An exterior surface of the mounting shaft, extending from the first end to the second end, is curved transverse to the mounting shaft axis, such that when the releasable calliper retains the mounting shaft, the calliper is pivotable on the mounting shaft about an axis perpendicular to the mounting shaft axis.

### CROSS-REFERENCE OF RELATED APPLICATION

This application claims the benefit of, and priority to, United Kingman Patent Application No. 1621499.1, filed on Dec. 16, 2016. The subject matter thereof is hereby incorporated by reference in its entirety.

### FIELD

The present invention relates to mounting assemblies configured to mount cargo to a fixing point.

### BACKGROUND

A typical prior art mounting assembly arrangement is shown in FIGS. 1a and 1b. A mounting assembly 10 is shown in FIG. 1a and comprises a base portion 11 that holds a cylindrical pin 17. The base portion 11 has a base plate 12 with a first pin mounting hole 16a in it. It also has a spacer back portion 14 and an end bracket 13 attached to the spacer back portion 14 and offset from the base plate 12. The end bracket 13 also has a pin mounting hole 16b in it, which lines up with the pin mounting hole 16a in the base plate 12. The cylindrical pin 17 is mounted in the holes 16a, 16b. There is defined a pin axis 18 extending the length of the pin 17. In addition, the spacer back portion 14 has two attachment holes 15a, 15b through it. These holes are used to attach the base 11 to cargo.

A corresponding calliper 20 is shown in FIG. 1b and comprises two arms 21, 22 which are pivotally mounted to each other at hinge 23. The arms 21, 22 extend past the hinge 23 where their internal surfaces are provided with a semi-cylindrical “cut out” so as to provide a hole 24 for the cylindrical pin 17. It is noted that the internal surface 25 of the hole 24 forms a flat ring and that the hole 24 has a hole axis 26. Tension straps (not shown) are provided attached to the arms 21, 22 in the holes in the arms. Having tension in these straps holds the callipers closed.

When the calliper hole 24 is attached around the pin 17, the mounting assembly 10 and calliper 20 can move in relation to each other by the calliper 20 pivoting around the pin 17, about the pin axis 18. The calliper 20 may also be able to slide up and down in relation to the pin 17. When needing to be released, a mechanical system (not shown) activates to release one of the tension straps holding the callipers closed. This causes the relevant arm of the calliper to pivot away from the other, therefore releasing the calliper.

However, a problem with such an arrangement is that the mounting assembly 10 and calliper 20 cannot move in any other way in relation to each other. This can be a problem, for example, when the angle of the pin 17 (i.e. the pin axis 18) makes it difficult to align the calliper hole axis 26 with that pin axis 18. It can also make release (when required) of the calliper difficult, especially when releasing cargo during flight or during aerial delivery. This can occur when the cargo is an inflatable, rigid boat, where the boat hull curves, or where the cargo is deformable through damage and/or use, causing the pin axis 18 to not be vertical, and so not correspond to the calliper hole axis 26.

Thus, it may be beneficial to mitigate the above-mentioned problems, and alternatively or additionally, provide an improved mounting assembly and/or releasable calliper.

### SUMMARY

Certain embodiments of the present invention may provide solutions to the problems and needs in the art that have not yet been fully identified, appreciated, or solved by current mounting assembly systems.

In an embodiment, a mounting assembly for attachment to cargo and for releasable attachment to a fixing point may include a base portion for attachment to the cargo. The mounting assembly also includes a mounting shaft retained by a releasable calliper attached to the fixing point. The mounting shaft having a first end attached to the base portion and a second opposite end. The mounting shafting has a mounting shaft axis extending between the two ends. An exterior surface of the mounting shaft, extending from the first end to the second end, is curved transverse to the mounting shaft axis, such that when the releasable calliper retains the mounting shaft, the calliper is pivotable on the mounting shaft about an axis perpendicular to the mounting shaft axis.

In another embodiment, an adaptor portion includes a loop member that is attached around a mounting shaft configured for attachment to cargo. The loop member defines a loop axis extending between a first end and a second opposite end of the loop member, and has an internal surface that extends from the first end to the second end and is curved transverse to the loop axis. The adaptor portion also includes a substantially cylindrical pin held by a conventionally shaped calliper attached to a fixing point.

In yet another embodiment, an adaptor portion includes a loop member attached around a substantially cylindrical pin configured for attachment to cargo. The adaptor portion also includes a mounting shaft retained by a releasable calliper attached to a fixing point. The mounting shaft has a first end and a second opposite end, and has a mounting shaft axis extending between the two ends. An exterior surface of the mounting shaft, extending from the first end to the second end, is curved transverse to the mounting shaft axis.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIGS. 1a and 1b show perspective views of a mounting assembly and releasable calliper of the prior art;

FIG. 2a shows a perspective view of a mounting assembly, according to an embodiment of the invention;

FIG. 2b shows a perspective view of a releasable calliper for use with the mounting assembly of FIG. 2a, according to an embodiment of the invention;

FIG. 3a shows a perspective view of an alternative mounting assembly for use with the releasable calliper of FIG. 2b, according to an embodiment of the invention;

FIG. 4a shows a perspective view of an adaptor assembly for use with the releasable calliper of FIG. 1b and the mounting assembly of FIG. 2a, 3a or 5b, according to an embodiment of the invention;

FIG. 4b shows a perspective view of the adaptor assembly of FIG. 4a, in use with the releasable calliper of FIG. 1b and the mounting assembly of FIG. 3a, according to an embodiment of the invention;

FIG. 4c shows a perspective view of an adaptor assembly for use with a releasable calliper of FIG. 2b and the mounting assembly of FIG. 1a, according to an embodiment of the invention;

FIG. 5a shows a perspective view of another mounting assembly, according to an embodiment of the invention; and

FIG. 5b shows a perspective view of another mounting assembly, according to an embodiment of the invention.

### DETAILED DESCRIPTION OF THE EMBODIMENTS

Some embodiments generally pertain to a mounting assembly configured for attachment to cargo and for releasable attachment to a fixing point. The fixing point may be on a platform, such as an aerial delivery platform, carrying the cargo. For example, the platform and cargo may be arranged to be ejected from an aircraft during aerial delivery. The releasable attachment may then be used for releasing the cargo from the platform in the air. In some embodiments, the fixing point may be on an inside of an aircraft. For example, the releasable attachment may be used to release the cargo from the aircraft to enable aerial delivery.

Certain embodiments pertain to a mounting assembly that includes a base portion configured for attachment to the cargo, and a mounting shaft configured for being retained by a releasable calliper attached to the fixing point. Some further embodiments may include a releasable calliper configured for releasably attaching cargo to a fixing point.

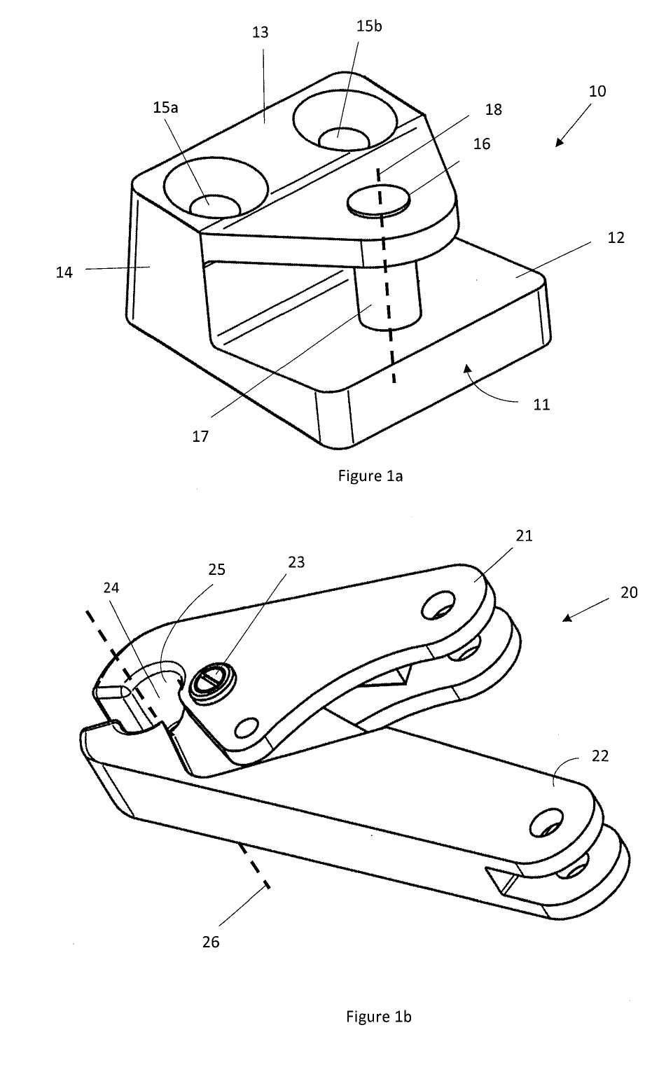

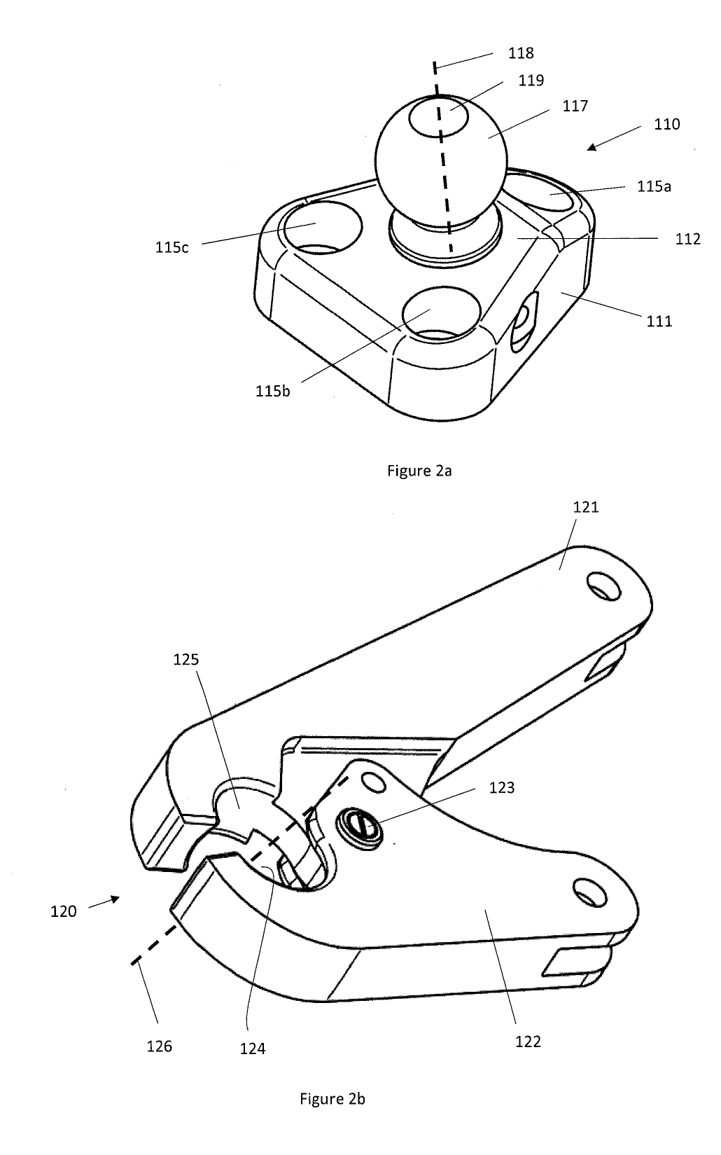

FIG. 2a shows a perspective view of a mounting assembly 110 according to an embodiment of the invention. The mounting assembly 110 is similar to the mounting assembly 10 of FIG. 1a in the sense that it has a base portion 111, with a base plate 112 that has a pin 117 mounted on it. There is defined a pin axis 118 extending the length of the pin 117. The pin 117 is on the end of a cylindrical spigot (not shown), which is inserted into a corresponding cylindrical hole (also not shown) in the centre of the base portion 111. It is secured in place with a pin, or similar, extending through the base portion 111 and the spigot. In addition, the base plate 112 has three attachment holes 115a, 115b, 115c through it. These holes are used to attach the base 111 to cargo.

An important difference between the mounting assembly 110 of FIG. 2a is that the pin 117 is in the form of a substantially spherical ball. The ball has a small flat-topped portion 119.

A corresponding calliper 120 is shown in FIG. 2b and is similar to the calliper of FIG. 1b. The calliper 120 comprises two arms 121, 122 which are pivotally mounted to each other at hinge 123. The arms 121, 122 extend past the hinge 123 where their internal surfaces provide a hole 124 for the spherical pin 117.

An important difference between the calliper 120 of FIG. 2b is that the internal surface 125 of the hole 124 is concave, i.e. the surface 125 is curved outwardly away from the hole axis 126.

When the calliper hole 124 is attached around the pin 117, the mounting assembly 110 and calliper 120 can move in relation to each other by the calliper 120 pivoting around the pin 117, about the pin axis 118. Importantly, the calliper 120 is also able to pivot so that the hole axis 126 is angled with respect to the pin axis 118, in two orthogonal axes.

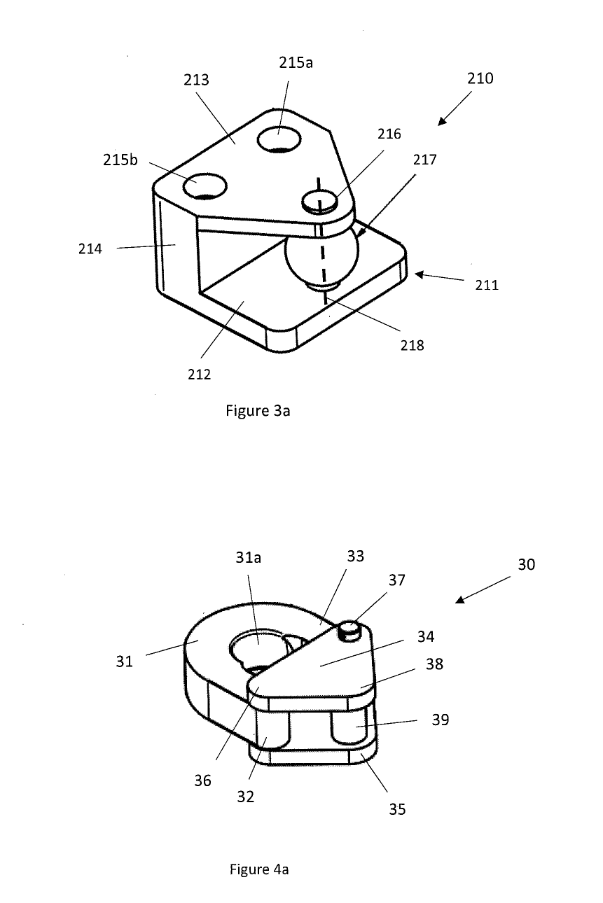

FIG. 3a shows a perspective view of an alternative mounting assembly 210 according to another embodiment of the invention, for use with the releasable calliper 120 of FIG. 2b. The mounting assembly 210 is similar to the mounting assembly 110 of FIG. 2a in the sense that it has a base portion 211, with a base plate 212 that has a substantially spherical pin 217 mounted on it. There is defined a pin axis 218 extending the length of the pin 217.

In a similar way to the mounting assembly 10 of FIG. 1a, the mounting assembly 210 also has a spacer back portion 214 and an end bracket 213 attached to the spacer back portion 214 and offset from the base plate 212. The end bracket 213 also has a pin mounting hole 216b in it, which lines up with a pin mounting hole (not shown) in the base plate 212. The cylindrical pin 217 is mounted in these pin mounting holes. In addition, the spacer back portion 214 has two attachment holes 215a, 215b through it. These holes are used to attach the base 211 to cargo.

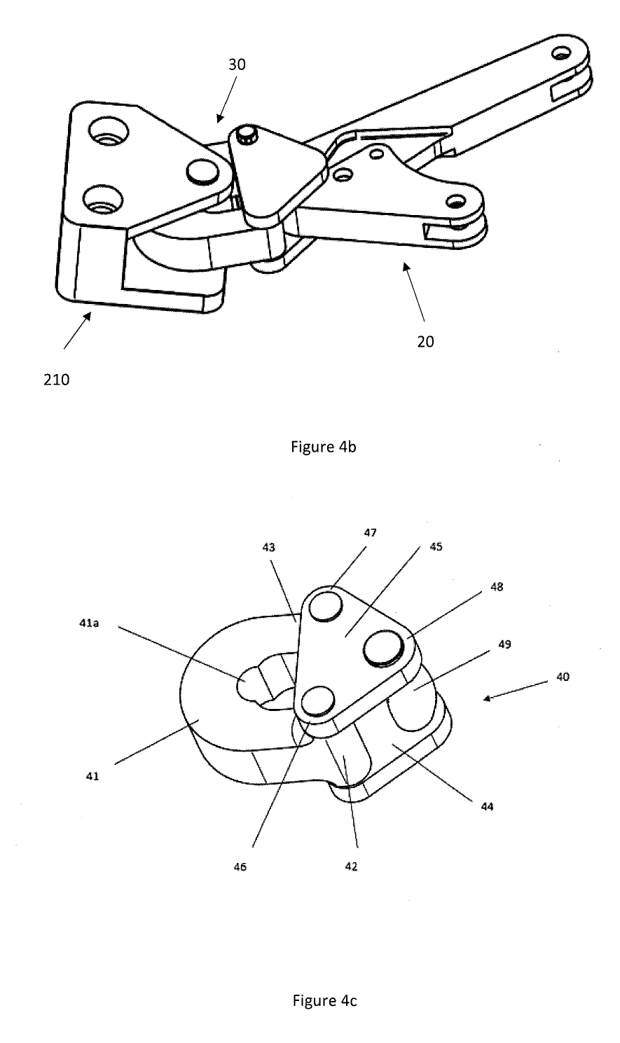

FIG. 4a shows a perspective view of an adaptor assembly 30 according to a fourth embodiment of the invention, for use with the releasable calliper 20 of FIG. 1b and the mounting assembly 110, 210, 410 of FIG. 2a, 3a or 5b. The adaptor assembly 30 provides a loop portion 31 with a concavely curved internal surface 31a, similar to the internal surface 125 of releasable callipers 120. One end 32 of the loop 31 is pivotally attached so as to be sandwiched at a corner 36 between two substantially triangular plates 34, 35. The other end 33 of the loop 31 is releasably attached to another corner 37 between the plates 34, 35. At a third corner 38 of the plates 34, 35 there is mounted between the plates a cylindrical pin 39.

FIG. 4b shows a perspective view of the adaptor assembly 30 of FIG. 4a, in use with the releasable calliper 20 of FIG. 1b and the mounting assembly 210 of FIG. 3a. Here, the concave internal surface 31a of the loop portion 31 of the adaptor assembly 30 is attached around the spherical pin 217 of the mounting assembly 210. The callipers 20 are then attached around the cylindrical pin 39 of the adaptor assembly 30. The adaptor assembly 30 allows for a conventional calliper 20 to be used with a mounting assembly 210 of the invention, whilst still ensuring that the internal surface 25 of the calliper 20 matches the surface 39 it is attached around and that the (spherical) surface 217 of the mounting assembly 210 is contained by a corresponding surface 31a.

FIG. 4c shows a perspective view of an adaptor assembly 40 according to an embodiment of the invention, for use with a releasable calliper 120 of FIG. 2b and the mounting assembly 10 of FIG. 1a. The adaptor assembly 40 provides a loop portion 41 with a curved internal surface 41a, corresponding to the cylindrical pin 17 of the mounting assembly 10. One end 42 of the loop 41 is pivotally attached so as to be sandwiched at a corner 46 between two substantially triangular plates 44, 45. The other end 43 of the loop 41 is releasably attached to another corner 47 between the plates 44, 45. At a third corner 48 of the plates 44, 45 there is mounted between the plates a curved pin 49, similar to pin 217 in FIG. 3a (described above). In use with the releasable calliper 120 of FIG. 2b and the mounting assembly 10 of FIG. 1a, the curved internal surface 41a of the loop portion 41 of the adaptor assembly 40 is attached around the cylindrical pin 17 of the mounting assembly 10. The callipers 120 with a concavely curved internal surface are then attached around the pin 49 of the adaptor assembly 40. The adaptor assembly 40 allows for a conventional mounting assembly 10 to be used with a releasable calliper 120 of the invention, whilst still ensuring that the internal concave surface 125 of the calliper 120 matches the surface 49 it is attached around and that the cylindrical pin 17 of the mounting assembly 10 is contained by a corresponding surface 41a.

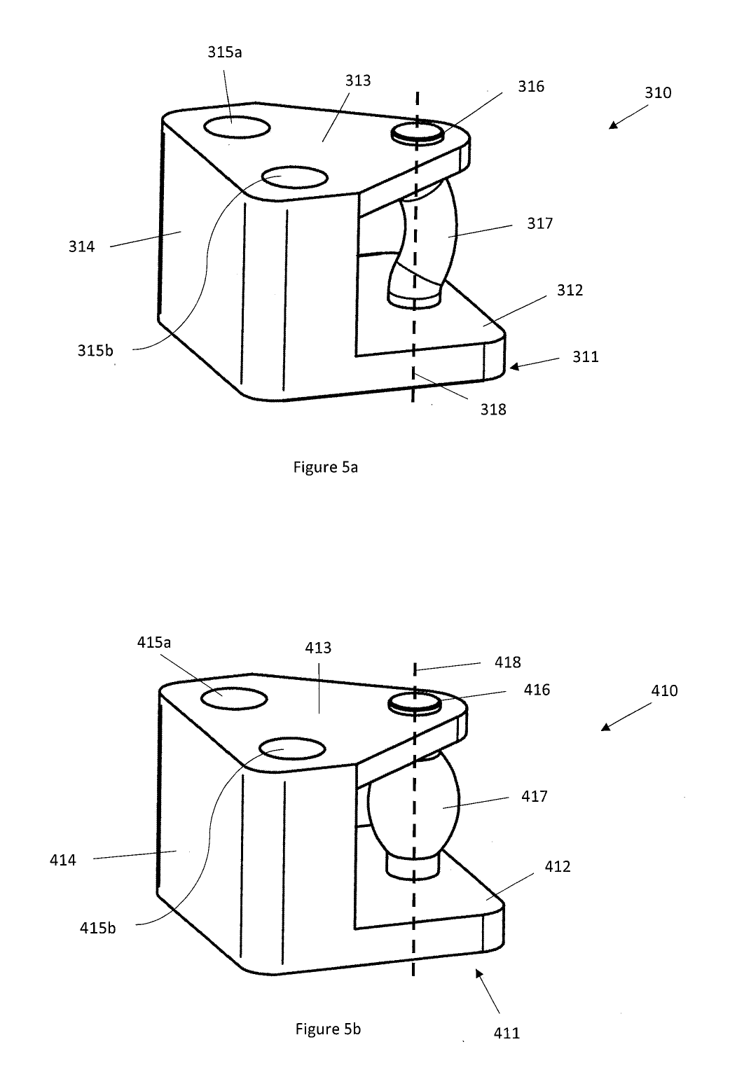

FIG. 5a shows a perspective view of another mounting assembly 310 according to an embodiment of the invention. The mounting assembly 310 is similar to the mounting assembly 210 of FIG. 3a in the sense that it has a base portion 311, with a base plate 312 that has a pin 317 mounted on it. There is defined a pin axis 318 extending in a straight line from one end of the pin to the other. The mounting assembly 310 also has a spacer back portion 314 and an end bracket 313 attached to the spacer back portion 314 and offset from the base plate 312. The end bracket 313 also has a pin mounting hole 316b in it, which lines up with a pin mounting hole (not shown) in the base plate 312. The pin 317 is mounted in these pin mounting holes. In addition, the spacer back portion 314 has two attachment holes 315a, 315b through it. These holes are used to attach the base 311 to cargo.

An important difference of this mounting assembly 310 is that the pin 317 is curved so that its surface extends away from the pin axis 318. When a corresponding calliper hole is attached around the pin 317, the mounting assembly 310 and calliper can move in relation to each other by the calliper pivoting around the pin 317. Importantly, the calliper is also able to pivot so that a hole axis of the calliper is angled with respect to the pin axis 118, depending on the position of the calliper along the curved pin 317.

FIG. 5b shows a perspective view of another mounting assembly 410 according to an embodiment of the invention. This mounting assembly 410 is similar to the mounting assembly 310 of FIG. 5a in that it has a base portion 411, with a base plate 412 that has a pin 417 mounted on it. There is defined a pin axis 418 extending in a straight line from one end of the pin to the other. The mounting assembly 410 also has a spacer back portion 414 and an end bracket 413 attached to the spacer back portion 414 and offset from the base plate 412. The end bracket 413 also has a pin mounting hole 416b in it, which lines up with a pin mounting hole (not shown) in the base plate 412. The pin 417 is mounted in these pin mounting holes. In addition, the spacer back portion 414 has two attachment holes 415a, 415b through it. These holes are used to attach the base 411 to cargo.

An important difference of this mounting assembly 410 is that the pin 417 is oval in shape. When a corresponding calliper hole is attached around the pin 417, the mounting assembly 410 and calliper can move in relation to each other by the calliper pivoting around the pin 417. Importantly, the calliper is also able to pivot so that a hole axis of the calliper is angled with respect to the pin axis 418, in two orthogonal axes.

Some embodiments generally pertain to a mounting assembly configured for attachment to cargo and releasable attachment to a fixing point. The mounting assembly may include a base portion configured for attachment to the cargo, and a mounting shaft configured for being retained by a releasable calliper attached to the fixing point. The mounting shaft may have a first end attached to the base portion and a second opposite end, thereby defining a mounting shaft axis extending between the two ends. An exterior surface of the mounting shaft, extending from the first end to the second end, is curved transverse to the mounting shaft axis, such that when the calliper is retaining the mounting shaft, the calliper is pivotable on the mounting shaft about an axis perpendicular to the mounting shaft axis.

Such a mounting assembly enables the mounting assembly to be mounted on cargo such that the mounting shaft axis can take a number of different angles, including non-vertical/horizontal angles, whilst still enabling a releasable calliper to retain the mounting shaft effectively and allow effective release of the mounting shaft, when required. Such a mounting assembly differs from the prior art “cylindrical pin” as the prior art pin is not curved transverse to the pin axis. Instead, the walls of the pin extend parallel to the pin axis. In addition, the prior art “cylindrical pin” only allows rotation/pivoting of the calliper about the pin/mounting shaft axis. The invention here allows the calliper to pivot about an axis perpendicular to the mounting shaft axis.

In some embodiments, the exterior surface of the mounting shaft, extending from the first end to the second end, is curved away from the mounting shaft axis over at least a portion of the shaft.

Also, in some embodiments, the mounting shaft provides such a curved surface around all sides of the shaft. This allows the callipers to pivot about an axis perpendicular to the shaft axis, irrespective of its rotational position around the shaft.

In some other embodiments, the mounting shaft is in the form of an ovoid. This allows the callipers to pivot around both axes that are perpendicular to the mounting shaft axis.

Alternatively, the mounting shaft is substantially spherical. Again, this allows the callipers to pivot around both axes that are perpendicular to the mounting shaft axis.

It also allows this pivoting with maximum flexibility/pivot angle.

In some embodiments, the mounting shaft is in the form of a curved pin so as to provide a convexly curved external surface on one side of the pin and a concavely curved external surface on an opposite side of the pin. This allows the callipers to pivot around one perpendicular axis, the axis being depending on the direction of curvature of the pin with respect to the mounting shaft axis.

Also, in some embodiments, the assembly also comprises an adaptor portion comprising a loop member configured for attaching around the mounting shaft, the loop member having an internal surface shaped to correspond to the shape of the mounting shaft, and a substantially cylindrical pin configured for being held by a conventionally shaped calliper.

Having an adaptor portion with both a matching internal shape of the loop and a cylindrical pin allows a conventional calliper to be used with a mounting assembly provided by an aspect of the invention, whilst still allowing the matching of the surfaces. The internal shape of the loop member may be concave to match a convex shape of the mounting shaft. Conventional callipers have an internal surface that simply matches to a cylindrical pin; it is not concave or convex.

In some embodiments, the loop member is releasable. This allows the adaptor portion to be easily removed from the mounting shaft.

Also, in some embodiments, the base portion comprises an end bracket configured for attaching over the second end of the mounting shaft. This ensures the callipers are not able to slip off the mounting shaft.

In yet some further embodiments, the mounting shaft (and cylindrical pin) is designed to withstand a tension force of 70 to 150 kN (70 to 150 kilo Newtons).

According to another embodiment, there is also provided an adaptor portion comprising a loop member configured for attaching around a mounting shaft configured for attachment to cargo, the loop member defining a loop axis extending between a first end and a second opposite end of the loop member, and having an internal surface, which extends from the first end to the second end and is curved transverse to the loop axis, and a substantially cylindrical pin configured for being held by a conventionally shaped calliper attached to a fixing point.

According to yet another embodiment, there is also provided an adaptor portion comprising a loop member configured for attaching around a substantially cylindrical pin configured for attachment to cargo, and a mounting shaft configured for being retained by a releasable calliper attached to a fixing point, the mounting shaft having a first end and a second opposite end, thereby defining a mounting shaft axis extending between the two ends, wherein an exterior surface of the mounting shaft, extending from the first end to the second end, is curved transverse to the mounting shaft axis.

According to some further embodiments, there is also provided a releasable calliper configured for releasably attaching cargo to a fixing point, the releasable calliper providing a loop configured for attaching around a mounting shaft attached to the cargo, the loop having an internal surface that, in use, extends around the mounting shaft, wherein the internal surface is curved transverse to the loop.

This allows the calliper to be used with a mounting assembly, as provided by an embodiment, whilst still allowing the matching of the surfaces.

In some embodiments, the internal surface of the loop is concavely curved to correspond to a convexly curved external surface of the mounting shaft.

According to yet another embodiment, there is also provided a releasable calliper configured for releasably attaching cargo to a fixing point, the releasable calliper providing a loop configured for attaching around a mounting shaft attached to the cargo, the loop providing one or more internal abutting surfaces that, in use, extend around the mounting shaft and wherein the internal abutting surfaces of the loop collectively provide an abutment means that is curved transverse to the loop.

In some embodiments, the internal abutting surfaces of the loop collectively provide an abutment means that is concavely curved to correspond to a convexly curved external surface of the mounting shaft.

It will of course be appreciated that features described in relation to one aspect of the present invention may be incorporated into other aspects of the present invention. For example, the apparatus of any aspect of the invention may incorporate any of the features described with reference to the apparatus of any other aspect of the invention.

It will be readily understood that the components of various embodiments of the present invention, as generally described and illustrated in the figures herein, may be arranged and designed in a wide variety of different configurations. Thus, the detailed description of the embodiments, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A mounting assembly for attachment to cargo and for releasable attachment to a fixing point, the mounting assembly comprising:
a base portion configured for attachment to the cargo; and
a mounting shaft retained by a releasable calliper attached to the fixing point, the mounting shaft having a first end attached to the base portion and a second opposite end, the mounting shaft having a mounting shaft axis extending between the two ends, wherein
an exterior surface of the mounting shaft, extending from the first end to the second end, is curved transverse to the mounting shaft axis, such that when the releasable calliper retains the mounting shaft, the calliper is pivotable on the mounting shaft about an axis perpendicular to the mounting shaft axis.

2. The mounting assembly of claim 1, wherein the mounting shaft provides a curved surface around all sides of the shaft.

3. The mounting assembly of claim 2, wherein the mounting shaft is in the form of an ovoid.

4. The mounting assembly of claim 2, wherein the mounting shaft is substantially spherical.

5. The mounting assembly of claim 2, wherein the mounting shaft is in the form of a curved pin to provide a convexly curved external surface on one side of the pin and a concavely curved external surface on an opposite side of the pin.

6. The mounting assembly of claim 1, further comprising an adaptor portion comprising:
a loop member attached around the mounting shaft, the loop member having an internal surface shaped to correspond to the shape of the mounting shaft, and
a substantially cylindrical pin held by a conventionally shaped calliper.

7. The mounting assembly of claim 6, wherein the loop member is releasable.

8. The mounting assembly of claim 6, wherein the base portion comprises an end bracket for attaching over the second end of the mounting shaft.

9. The mounting assembly of claim 6, wherein the cylindrical pin is configured to withstand a tension force of 70 to 150 kN.

10. The mounting assembly of claim 1, wherein the mounting shaft is configured to withstand a tension force of 70 to 150 kN.

11. An adaptor portion, comprising:
a loop member attached around a mounting shaft configured for attachment to cargo, the loop member defining a loop axis extending between a first end and a second opposite end of the loop member, and having an internal surface that extends from the first end to the second end and is curved transverse to the loop axis, and
a substantially cylindrical pin held by a conventionally shaped calliper attached to a fixing point.

12. An adaptor portion, comprising:
a loop member attached around a substantially cylindrical pin configured for attachment to cargo, and
a mounting shaft retained by a releasable calliper attached to a fixing point, the mounting shaft having a first end and a second opposite end, and having a mounting shaft axis extending between the two ends, wherein
an exterior surface of the mounting shaft, extending from the first end to the second end, is curved transverse to the mounting shaft axis.

13. The adaptor portion of claim 12, wherein the releasable calliper is configured to releasably attach cargo to a fixing point, and provide a loop that attaches around a mounting shaft attached to the cargo, the loop having an internal surface that, in use, extends around the mounting shaft, wherein the internal surface is curved transverse to the loop.

14. The adaptor portion of claim 13, wherein the internal surface of the loop is concavely curved to correspond to a convexly curved external surface of the mounting shaft.

15. The adaptor portion of claim 12, wherein the releasable calliper is configured to releasably attach cargo to a fixing point, and provide a loop to attach around a mounting shaft attached to the cargo, the loop provides one or more internal abutting surfaces that, in use, extend around the mounting shaft, and the internal abutting surfaces of the loop collectively provide an abutment means that is curved transverse to the loop.

16. The adaptor portion of claim 15, wherein the internal abutting surfaces of the loop provide an abutment means that is concavely curved to correspond to a convexly curved external surface of the mounting shaft.
